(19) United States
(12) Patent Application Publication
(10) Pub. No.: US 2024/0063479 A1
(43) Pub. Date: Feb. 22, 2024

(54) BATTERY CELL ASSEMBLY

(71) Applicants: HYUNDAI MOTOR COMPANY, Seoul (KR); KIA CORPORATION, Seoul (KR)

(72) Inventor: Kyungmo Kim, Hwaseong-si (KR)

(73) Assignees: HYUNDAI MOTOR COMPANY, Seoul (KR); KIA CORPORATION, Seoul (KR)

(21) Appl. No.: 18/227,172

(22) Filed: Jul. 27, 2023

(30) Foreign Application Priority Data
Aug. 18, 2022 (KR) 10-2022-0103616

(51) Int. Cl. H01M 50/136; H01M 50/103; H01M 50/505; H01M 50/557

(52) U.S. Cl. CPC H01M 50/136; H01M 50/103; H01M 50/505; H01M 50/557

(57) ABSTRACT

A battery cell assembly includes: a folding cell in which a solid-state unit cell in a sheet form is folded in a zigzag form; a first terminal plate disposed on a first side with reference to a folding direction of the folding cell, electrically connected to the folding cell through at least one first electrode terminal, and formed with at least one protrusion portion configured to support the at least one first electrode terminal; and a second terminal plate disposed on a second side with reference to the folding direction of the folding cell, electrically connected to the folding cell through at least one second electrode terminal, and formed with at least one recess portion configured to support the at least one second electrode terminal.

### CROSS-REFERENCE TO RELATED APPLICATION

This application claims priority to and the benefit of Korean Patent Application No. 10-2022-0103616 filed in the Korean Intellectual Property Office on Aug. 18, 2022, the entire contents of which are incorporated herein by reference.

### BACKGROUND

### (a) Field of the Disclosure

The present disclosure relates to a battery cell assembly. More particularly, the present disclosure relates to a battery cell assembly made of solid-state rechargeable battery cells (e.g., polymer-based rechargeable battery cells).

### (b) Description of the Related Art

Due to recently strengthened environmental regulations and fuel efficiency regulations, use of environment-friendly vehicles such as hybrid vehicles and electric vehicles is increasing

Such an environment-friendly vehicle is equipped with a high-voltage battery system configured to supply electricity to an electric driving power source. The high-voltage battery system includes a battery pack in which a plurality of battery cells is electrically connected.

An example of a unit battery cell that is currently widely used may be a unit rechargeable battery cell, and furthermore, a pouch-type lithium-ion battery cell using a liquid electrolyte.

When configuring a battery pack by electrically connecting a plurality of such battery cells, it is typical to first configure at least one battery module in which a plurality of battery cells is stacked and then add other components to configure the battery pack. The at least one battery module is installed in a pack housing and the pack housing is assembled to the vehicle body.

On the other hand, in the case of an electric vehicle, it is important to secure an output voltage or a charging and discharging capacity of the plurality of battery cells included in the battery pack. In addition, a major factor affecting the mileage of the electric vehicle is the energy capacity ratio of the plurality of battery cells. In other words, as more battery cells are mounted in a limited space of the battery pack, the mileage of the electric vehicle increases.

However, the pack housing and the at least one battery module provided as components may overlap with each other in the mechanical structure. An installation capacity (e.g., capacity ratio) of the plurality of battery cells may thereby be deteriorated.

On the other hand, the at least one battery module requires a component for surface-pressurizing the plurality of battery cells using the liquid electrolyte and a component for controlling a swelling reaction force of the plurality of battery cells.

Furthermore, the battery pack in which the at least one battery module is mounted requires a cooling component for cooling the plurality of battery cells. In addition, the battery pack also requires a weft-designed welding structure for electrically interconnecting the plurality of battery cells.

Therefore, in a conventional battery assembly structure, due to an increase in the number of parts, it is difficult to maximize the installation capacity (e.g., installation volume) of the plurality of battery cells and an increase in the number of assembly processes may result.

The above information disclosed in this Background section is only to enhance understanding of the background of the disclosure. Therefore, the Background section may contain information that does not form the prior art that is already known to a person of ordinary skill in the art.

### SUMMARY

The present disclosure attempts to provide a battery cell assembly capable of maximizing voltage capacity of a battery cell, maximizing volumetric efficiency of the battery cell in a limited space, and simplifying assembly components and assembly processes.

A battery cell assembly includes a folding cell in which a solid state unit cell in a sheet form is folded in a zigzag form. The battery cell assembly also includes a first terminal plate that is disposed on a first side with reference to a folding direction of the folding cell, that is electrically connected to the folding cell through at least one first electrode terminal, and that is formed with at least one protrusion portion configured to support the at least one first electrode terminal. The battery assembly also includes a second terminal plate that is disposed on a second side with reference to the folding direction of the folding cell, that is electrically connected to the folding cell through at least one second electrode terminal, and that is formed with at least one recess portion configured to support the at least one second electrode terminal.

A battery cell assembly may further include a cell housing that may have a first penetration hole connected to the at least one recess portion and that may be configured to accommodate the folding cell, the first terminal plate, and the second terminal plate that are connected to each other. The battery cell assembly may also include a housing cover that may have a second penetration hole into which the at least one protrusion portion is inserted and that is coupled to the cell housing.

The battery cell assembly may be configured in a prismatic type and provided in a plural quantity.

The battery cell assembly may be assembled with another neighboring battery cell assembly in the form of bricks via the at least one protrusion portion on one of the battery cell assemblies and the at least one recess portion on the other battery cell assembly.

The folding cell may further include a fixing tape adhered along the folding direction to a plurality of folding layers folded in an S-shape.

The second terminal plate may include a cell coupling protrusion formed with the at least one recess portion.

The folding cell may be formed with a coupling hole coupled to the cell coupling protrusion.

The at least one first electrode terminal and the at least one second electrode terminal may include a terminal portion in a ring shape and a sensing busbar extending from the terminal portion. The sensing busbar may be electrically connected to at least one among a positive electrode lead and a negative electrode lead provided in the folding cell.

The first terminal plate and the second terminal plate may be formed of an insulation material and may include a rib configured to support the sensing busbar.

The at least one protrusion portion may be provided as a pair of the protrusion portions.

The at least one first electrode terminal may include a first positive electrode terminal that is coupled to a first one among a pair of protrusion portions and that is electrically connected to a positive electrode lead provided in the folding cell. The at least one first electrode terminal may also include a first negative terminal that is coupled to a second one among the pair of protrusion portions and that is electrically connected to a negative electrode lead provided in the folding cell.

The at least one recess portion may be provided as a pair of the recess portions.

The at least one second electrode terminal may include a second positive electrode terminal that is coupled to a first one among a pair of recess portions and that is electrically connected to the positive electrode lead provided in the folding cell. The at least one second electrode terminal may also include a second negative terminal that is coupled to a second one among the pair of recess portions and that is electrically connected to the negative electrode lead provided in the folding cell.

A battery cell assembly may further include a plurality of sensing block units coupled to the cell housing and electrically connected to the at least one first electrode terminal and the at least one second electrode terminal.

The plurality of sensing block units may include a block body coupled to the cell housing. The plurality of sensing block units may also include a connector that is coupled to a hook protrusion extending from the block body toward an interior of the cell housing and that is electrically connected to the at least one first electrode terminal and the at least one second electrode terminal.

The block body may be adhered to an outer surface of the cell housing through a double-sided adhesive tape.

A hook groove coupled to the hook protrusion and the connector may be formed in the first terminal plate and the second terminal plate.

The protrusion portion may be provided as a pair of the protrusion portions. The at least one first electrode terminal may include a first positive electrode terminal that is coupled to a first one among the pair of protrusion portions and that is electrically connected to a positive electrode lead provided in the folding cell.

The recess portion may be provided as a pair of the recess portions. The at least one second electrode terminal may include a first negative terminal that is coupled to a first one among a pair of recess portions and that is electrically connected to a negative electrode lead provided in the folding cell.

The protrusion portion may be provided as a pair of the protrusion portions. The at least one first electrode terminal may include a first negative terminal that is coupled to a first one among the pair of protrusion portions and that is electrically connected to a negative electrode lead provided in the folding cell.

The recess portion may be provided as a pair of the recess portions. The at least one second electrode terminal may include a first positive electrode terminal that is coupled to a first one among the pair of recess portions and that is electrically connected to a positive electrode lead provided in the folding cell.

According to embodiments, the voltage capacity of a solid-state unit cell may be increased, the volumetric efficiency of the battery cell in a limited space may be maximized, and the number of assembly parts and assembly processes may be decreased.

Other effects that may be obtained or achieved by an embodiment are explicitly or implicitly described in a detailed description of the present disclosure. In other cords, various effects that may be achieved according to an embodiment of the present disclosure are described in the following detailed description.

### BRIEF DESCRIPTION OF THE DRAWINGS

The drawings are intended to be used as references for describing embodiments of the present disclosure, and the accompanying drawings should not be construed as limiting the technical spirit of the present disclosure.

FIG. 1 illustrates top and bottom perspective views of a battery cell assembly according to an embodiment of the present disclosure,

FIGS. 2 and 3 are top and bottom exploded perspective views of a battery cell assembly according to an embodiment of the present disclosure.

FIGS. 4 and 5 show top and bottom views of a folding cell applied to a battery cell assembly according to an embodiment of the present disclosure.

FIG. 6 schematically illustrates a state of a folding cell before folding is applied to a battery cell assembly according to an embodiment of the present disclosure.

FIGS. 7-9 illustrate top views of a connection structure of a folding cell and a first terminal plate applied to a battery cell assembly according to an embodiment of the present disclosure.

FIGS. 10-12 illustrate bottom views of a connection structure of a folding cell and a second terminal plate applied to a battery cell assembly according to an embodiment of the present disclosure.

FIG. 13 shows a sensing block unit applied to a battery cell assembly according to an embodiment of the present disclosure.

FIGS. 14-17A show views of an operation of a battery cell assembly and FIGS. 17B and 17C show alternative battery cell assemblies according to embodiments of the present disclosure.

FIGS. 18-20 show views of a battery cell assembly according to another embodiment of the present disclosure.

FIGS. 21-23 show views of a battery cell assembly according to another embodiment of the present disclosure.

It should be understood that the above-referenced drawings are not necessarily drawn to scale, presenting a somewhat simplified representation of various features illustrative of the basic principles of the disclosure. The specific design features of the present disclosure, including, for example, specific dimensions, orientations, locations, and shapes, will be determined in part by the particular intended application and use environment.

### DETAILED DESCRIPTION

The technical concepts of the present disclosure are described more fully hereinafter with reference to the accompanying drawings, in which embodiments of the disclosure are shown. As those having ordinary skill in the art should realize, the described embodiments may be modified in various different ways, all without departing from the spirit or scope of the present disclosure.

The terminology used herein is for the purpose of describing particular embodiments only and is not intended to be limiting of the present disclosure. As used herein, the singular forms are intended to include the plural forms as well, unless the context clearly indicates otherwise.

As used herein, the terms “comprises” and/or “comprising” refer to the presence of specified features, integers, steps, acts, elements and/or components. However, it should also be understood that the terms do not exclude a presence or an addition of one or more other features, integers, steps, acts, components, and/or groups thereof. As used herein, the term “and/or” includes any one or all combinations of one or more related items. The term “coupled” denotes a physical relationship between two components in which components are directly connected to each other or indirectly connected through one or more intermediary components, for example, by welding, serf-piercing riveting (SPR), or structural bonding.

It should be understood that the terms “vehicle,” “vehicular,” “car,” or other similar terms as used herein are inclusive of, in general, passenger automobiles including sport cars, sports utility vehicles (SUV), buses, trucks, and various commercial vehicles. The terms are also inclusive of hybrid vehicles, electric vehicles, hybrid electric vehicles, hydrogen-powered vehicles, purpose-built vehicles (PBV), and other alternative fuel vehicles (e.g., fuels derived from resources other than petroleum).

Hereinafter, examples or embodiments of the present disclosure are described in detail with reference to the accompanying drawings.

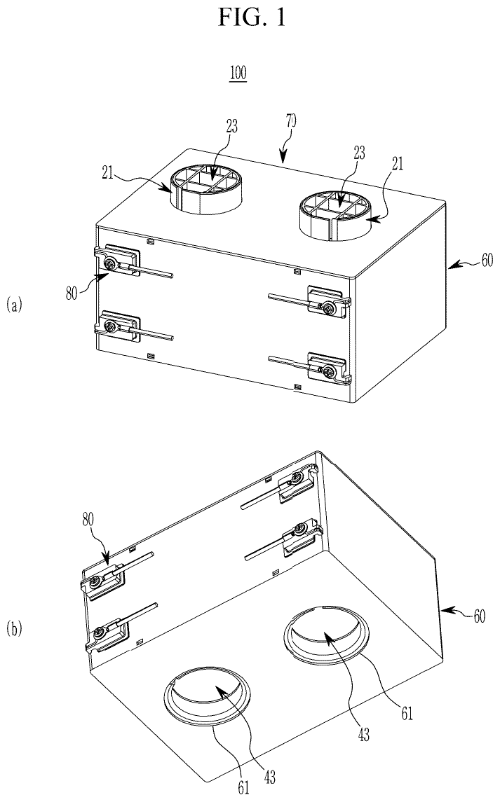

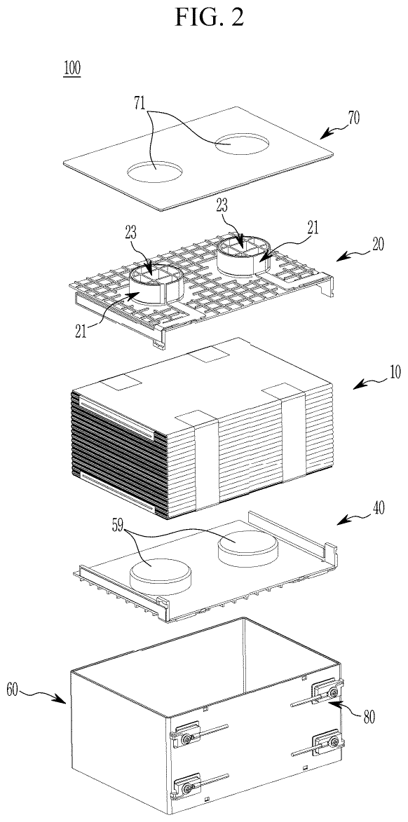

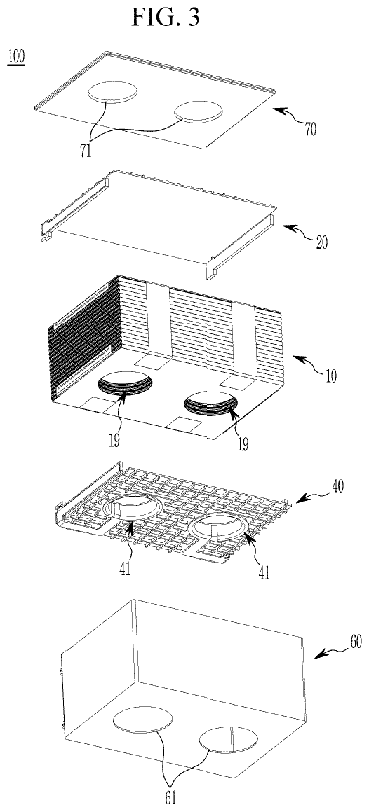

FIG. 1 illustrates top and bottom perspective views of a battery cell assembly according to an embodiment. FIGS. 2 and 3 are respective top and bottom exploded perspective views of a battery cell assembly according to an embodiment.

Referring to FIGS. 1-3, a battery cell assembly 100 according to an embodiment may be configured in a battery assembly (e.g., pack tray) mounted on a vehicle body of an environment-friendly vehicle.

The environment-friendly vehicle may include a hybrid vehicle, an electric vehicle, a hydrogen-powered vehicle (frequently called a ‘hydrogen electric vehicle’ by those having ordinary skill in the art), and a purpose-built mobility vehicle (PBV vehicle) based on the electric vehicle.

In an example, the battery assembly may be mounted on a body of an electric vehicle during a process of assembling various components to the body of the electric vehicle. The battery assembly may be mounted on a lower portion of the vehicle body, such as for example, a chassis frame, a rolling chassis, or a skateboard type body structure.

In the present disclosure, the reference direction for describing the components below may be set as a reference, in one example, as shown in the drawings, when the battery cell assembly 100 according to an embodiment is vertically placed and viewed.

Furthermore, in this specification, “top”, “Lipper-end portion”, “upper portion”, “upper end”, or “upper portion surface” of a component indicates an end portion, portion, end, or surface of the component that is relatively positioned higher in the drawings. Likewise, “bottom”, “lower end portion”, “lower portion”, “lower end”, or “lower portion surface” of a component indicates an end portion, portion, end, or surface of the component that is relatively positioned lower in the drawings.

In addition, in this specification, “end” (for example, one end, another end, or the like) of a component indicates an end of the component in any direction, and “end portion” (for example, one end portion, another end portion, or the like) of a component indicates a certain part of the component including the end.

The battery cell assembly 100 according to an embodiment may be provided in a plural quantity, i.e., a plurality of the battery cell assemblies may be provided and joined or connected to one another. In addition, such a plurality of battery cell assemblies 100 are disposed (or arranged) in a preset direction inside the pack tray of the battery assembly and may be electrically interconnected.

The battery cell assembly 100 according to an embodiment may be configured in a prismatic type. Furthermore, the battery cell assembly 100 according to an embodiment may be formed of, in an example, a unit cell of a solid-state rechargeable battery using a polymer-based electrolyte.

The unit cell of the solid-state rechargeable battery provides advantages such as showing excellent safety without explosion and ignition characteristics, being capable of achieving high energy density, enabling high output power, ensuring stable performance in a wide temperature range, and having a simple cell structure.

Due to the characteristics of the unit cell of the solid-state rechargeable battery, the battery cell assembly 100 according to an embodiment may provide the features of no cooling, no pressurization, and no welding. The battery cell assembly 100 is structured to achieve high voltage capacity of the unit cell of the solid-state rechargeable battery and maximum volumetric efficiency of the battery cell in the limited space

For such a purpose, the battery cell assembly 100 according to an embodiment may include a folding cell 10, a first terminal plate 20, a second terminal plate 40, a cell housing 60, a housing cover 70, and a plurality of sensing block units 80.

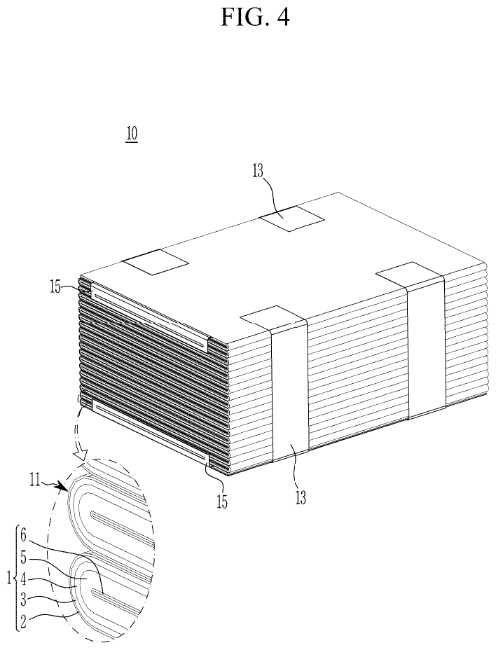

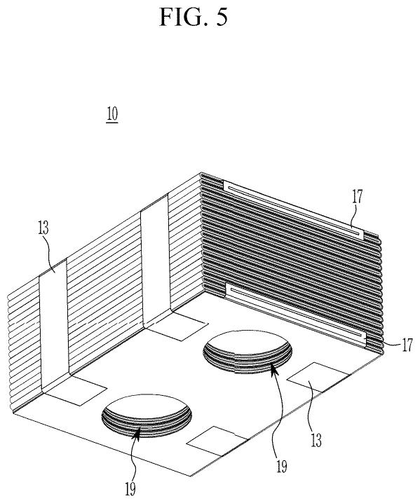

FIGS. 4 and 5 show a folding cell applied to a battery cell assembly according to an embodiment.

Referring to FIGS. 4 and 5, in an embodiment, the folding cell 10 may be applied to a battery assembly having a cell-to-pack (CTP) structure.

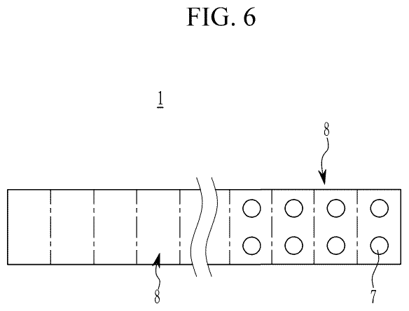

As shown in FIG. 6, the folding cell 10 has a cell structure in which unit cells 1 (hereinafter, referred to as a solid-state unit cell, for convenience) of the solid-state rechargeable battery fabricated in a sheet form are folded in a zigzag form.

The solid-state unit cell 1 in the sheet form may be provided as a cell having stacking (e.g., lamination) of a negative electrode current collector 2, a lithium metal layer 3, a solid electrolyte membrane 4, a positive electrode active material 5, and a positive electrode current collector 6 (refer to FIG. 4).

Furthermore, the solid-state unit cell 1 in the sheet form includes a plurality of punched holes 7 that are punched (or notched), formed by pairs, at a preset interval from a starting end of folding.

The solid-state unit cell 1 in the sheet form may include a plurality of folding sections 8 that are partitioned from the starting end of folding at a uniform length and that are folded in an S-shape with respect to a vertical direction and may form the folding cell 10 according to an embodiment. The solid-state unit cell 1 is formed with the plurality of punched holes 7 in the plurality of folding sections 8, from the starting end of folding.

The folding cell 10 according to an embodiment includes a plurality of folding layers 11 in which the plurality of folding sections 8 are arranged in the S-shape with respect to the vertical direction.

In addition, the folding cell 10 includes a fixing tape 13 adhered to the plurality of folding layers 11 along a folding direction (e.g., the vertical direction). The fixing tape 13 is provided in the form of a flexible band to which an adhesive is applied and is intended to fix the plurality of folding layers 11.

Furthermore, the folding cell 10 includes a positive electrode lead 15 extending from the positive electrode current collector 6 and includes a negative electrode lead 17 extending from the negative electrode current collector 2.

The positive electrode lead 15 is disposed at upper and lower portions of a first side surface of the folding cell 10. In addition, the negative electrode lead 17 is disposed at upper and lower portions of a second side surface of the folding cell 10.

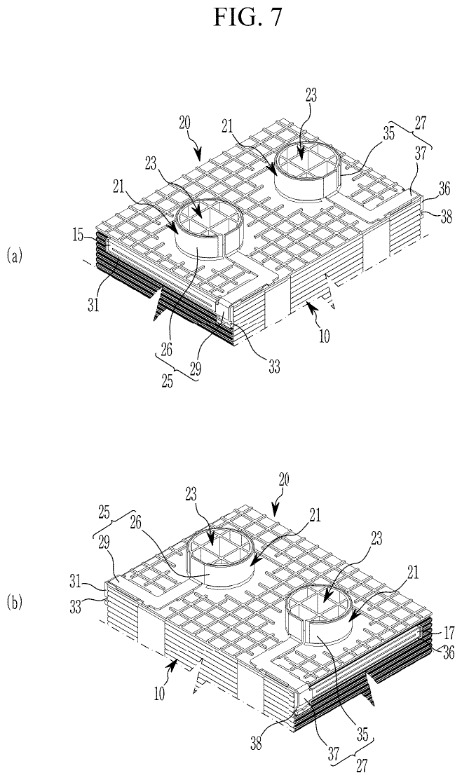

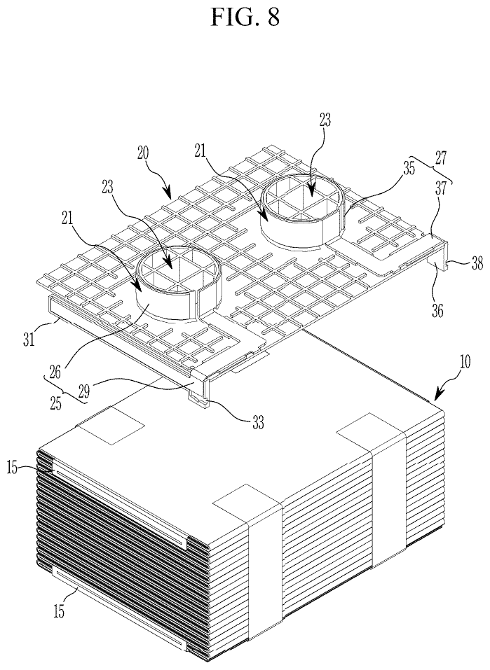

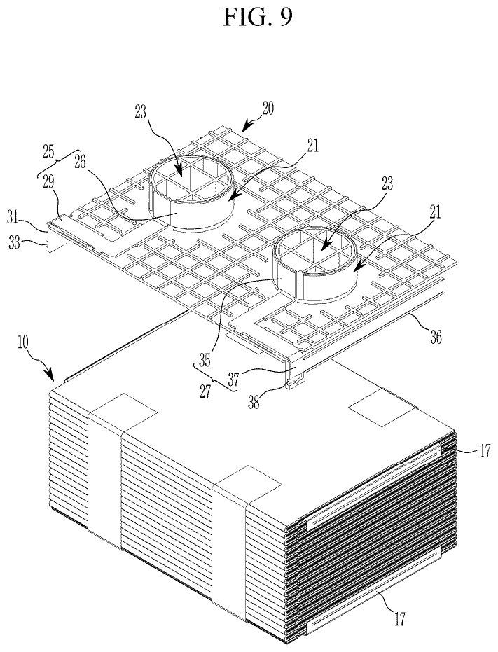

FIGS. 7-9 illustrate top views of a connection structure of a folding cell and a first terminal plate applied to a battery cell assembly according to an embodiment.

Referring to FIGS. 7-9, in an embodiment, the first terminal plate 20 (frequently called a sensing plate by those having ordinary skill in the art) is disposed on a first side (e.g., upper portion) with reference to the folding direction of the folding cell 10.

The first terminal plate 20 is formed of an insulation material and is electrically connected to the folding cell 10 through at least one first electrode terminal 21. The at least one first electrode terminal 21 may be electrically connected to the positive electrode lead 15 and the negative electrode lead 17 of the folding cell 10.

Furthermore, the first terminal plate 20 includes at least one protrusion portion 23 configured to support the at least one first electrode terminal 21. The at least one protrusion portion 23 is provided in a protrusion form that extends upward from an upper surface of the first terminal plate 20.

The at least one protrusion portion 23 may be provided as a pair of the protrusion portions 23. The at least one first electrode terminal 21 includes a first positive electrode terminal 25 coupled to a first one among the pair of protrusion portions 23 and a first negative terminal 27 coupled to a second one among the pair of protrusion portions 23.

The first positive electrode terminal 25 may be electrically connected to the positive electrode lead 15 of the folding cell 10. The first positive electrode terminal 25 includes a first terminal portion 26 and a first sensing busbar 29.

The first terminal portion 26 is provided in a ring shape and coupled to a first one among the pair of protrusion portions 23. The first sensing busbar 29 extends from the first terminal portion 26 and may be electrically connected to the positive electrode lead 15 of the folding cell 10.

The first sensing busbar 29 may be disposed to a first rib 31 extending from a first side edge portion of the first terminal plate 20. The first rib 31 is configured to support the first sensing busbar 29.

The first sensing busbar 29 may be in tight contact with the positive electrode lead 15 through the first rib 31. Alternatively, the first sensing busbar 29 may be connected to the positive electrode lead 15 by laser welding. Furthermore, a first hook groove 33 is formed on the first rib 31.

In addition, the first negative terminal 27 may be electrically connected to the negative electrode lead 17 of the folding cell 10. The first negative terminal 27 includes a second terminal portion 35 and a second sensing busbar 37.

The second terminal portion 35 is provided in a ring shape and coupled to the second one among the pair of protrusion portions 23. The second sensing busbar 37 extends from the second terminal portion 35 and may be electrically connected to the negative electrode lead 17 of the folding cell 10. The second sensing busbar 37 may be disposed to a second rib 36 extending from a second side edge portion of the first terminal plate 20. The second rib 36 is configured to support the second sensing busbar 37.

The second sensing busbar 37 may be in tight contact with the negative electrode lead 17 through the second rib 36. Alternatively, the second sensing busbar 37 may be connected to the negative electrode lead 17 by laser welding. Furthermore, a second hook groove 38 is formed on the second rib 36.

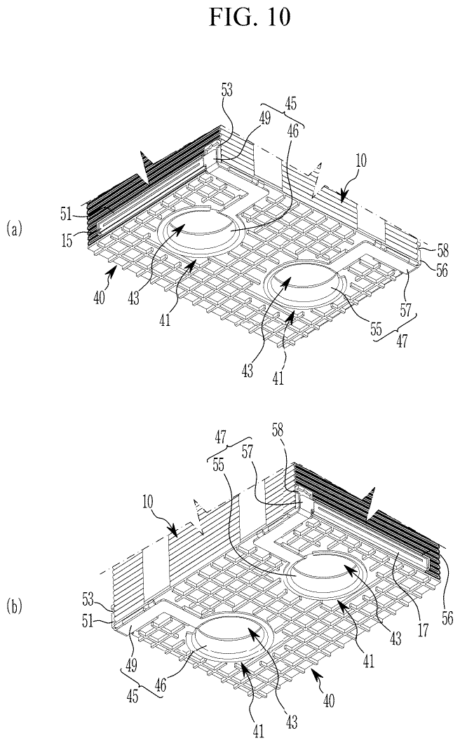

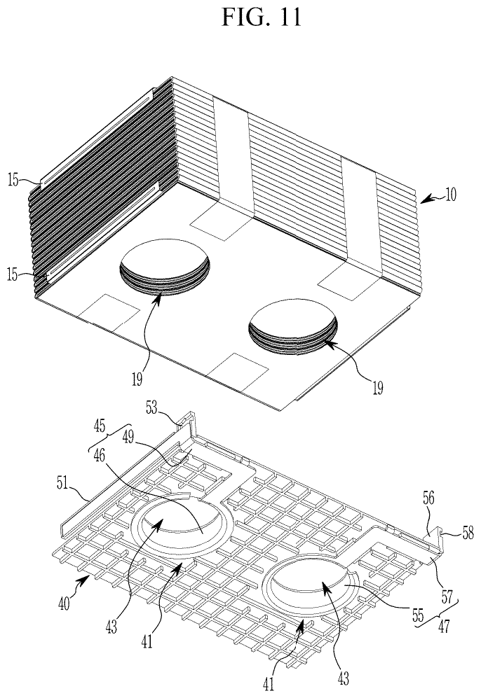

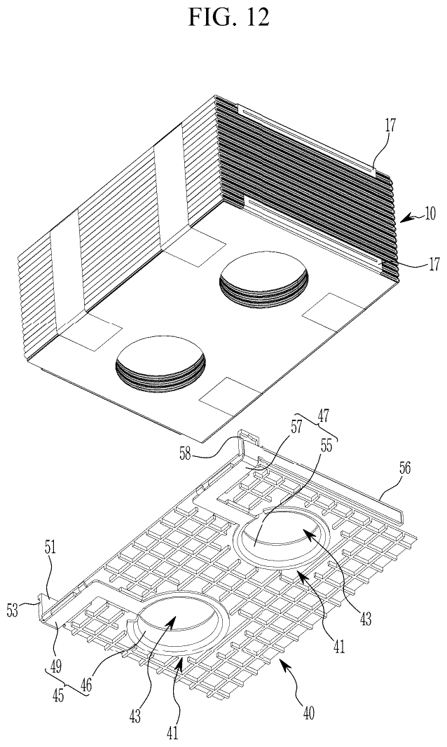

FIGS. 10-12 illustrate bottom views of a connection structure of a folding cell and a second terminal plate applied to a battery cell assembly according to an embodiment.

Referring to FIGS. 10-12, in an embodiment, the second terminal plate (frequently called a sensing plate by those having ordinary skill in the art) is disposed on a second side (e.g., lower portion) with reference to the folding direction of the folding cell 10.

The second terminal plate 40 is formed of an insulation material and is electrically connected to the folding cell 10 through at least one second electrode terminal 41. The at least one second electrode terminal 41 may be electrically connected to the positive electrode lead 15 and the negative electrode lead 17 of the folding cell 10.

Furthermore, the second terminal plate 40 includes at least one recess portion 43 configured to support the at least one second electrode terminal 41. The at least one recess portion 43 is provided in a groove form extending upward from a lower surface of the second terminal plate 40.

The at least one recess portion 43 may be provided as a pair of the recess portions 43. The at least one second electrode terminal 41 includes a second positive electrode terminal 45 coupled to a first one among the pair of recess portions 43 and a second negative terminal 47 coupled to a second one among the pair of recess portions 43.

The second positive electrode terminal 45 may be electrically connected to the positive electrode lead 15 of the folding cell 10. The second positive electrode terminal 45 includes a third terminal portion 46 and a third sensing busbar 49.

The third terminal portion 46 is provided in a ring shape and coupled to the first one among the pair of recess portions 43. The third sensing busbar 49 extends from the third terminal portion 46 and may be electrically connected to the positive electrode lead 15 of the folding cell 10.

The third sensing busbar 49 may be disposed to a third rib 51 extending from a first side edge portion of the second terminal plate 40. The third rib 51 is configured to support the third sensing busbar 49.

The third sensing busbar 49 may be in tight contact with the positive electrode lead 15 through the third rib 51. Alternatively, the third sensing busbar 49 may be connected to the positive electrode lead 15 by laser welding. Furthermore, a third hook groove 53 is formed on the third rib 51.

In addition, the second negative terminal 47 may be electrically connected to the negative electrode lead 17 of the folding cell 10. The second negative terminal 47 includes a fourth terminal portion 55 and a fourth sensing busbar 57.

The fourth terminal portion 55 is provided in a ring shape and coupled to the second one among the pair of recess portions 43. The fourth sensing busbar 57 extends from the fourth terminal portion 55 and may be electrically connected to the negative electrode lead 17 of the folding cell 10.

The fourth sensing busbar 57 may be disposed to a fourth rib 56 extending from a second side edge portion of the second terminal plate 40. The fourth rib 56 is configured to support the fourth sensing busbar 57.

The fourth sensing busbar 57 may be in tight contact with the negative electrode lead 17 through the fourth rib 56. Alternatively, the fourth sensing busbar 57 may be connected to the negative electrode lead 17 by laser welding. Furthermore, a fourth hook groove 58 is formed on the fourth rib 56.

The second terminal plate 40 includes a cell coupling protrusion 59 (hereinafter, refer to FIG. 2) formed with the at least one recess portion 43 (e.g., the pair of recess portions 43). The cell coupling protrusion 59 is provided in the form protruding upward from an upper surface of the second terminal plate 40 the at least one recess portion 43.

The cell coupling protrusion 59 may be coupled to a coupling hole 19 (refer to FIGS. 3, 5 and 11) formed in the folding cell 10. The coupling hole 19 may be formed by the plurality of punched holes 7 as shown in FIG. 6.

Referring to FIGS. 1-3, in an embodiment, the cell housing 60 is configured to accommodate the folding cell 10, the first terminal plate 20, and the second terminal plate 40 that are connected to each other.

The cell housing 60 is provided in the form of a case with an open top. In an example, the cell housing 60 may have a rectangular cross-section. The cell housing 60 includes a first penetration hole 61 connected to the at least one recess portion 43 of the second terminal plate 40. The first penetration hole 61 is formed on a lower bottom surface of the cell housing 60. A pair of the first penetration holes 61 may be provided to respectively accommodate a pair of the recess portions 43.

Referring to FIGS. 1-3, in an embodiment, the housing cover 70 is coupled to an upper end of the cell housing 60. In an example, the housing cover 70 may be provided as a rectangular plate.

The housing cover 70 includes a second penetration hole 71 into which the at least one protrusion portion 23 of the first terminal plate 20 is inserted. A pair of the second penetration holes 71 may be provided to respectively accommodate a pair of the protrusion portions 23.

Referring to FIGS. 1-3, in an embodiment, the plurality of sensing block units 80 is configured to sense voltage information of the folding cell 10.

The plurality of sensing block units 80 may be coupled to the cell housing 60 and may be electrically connected to the at least one first electrode terminal 21 and the at least one second electrode terminal 41.

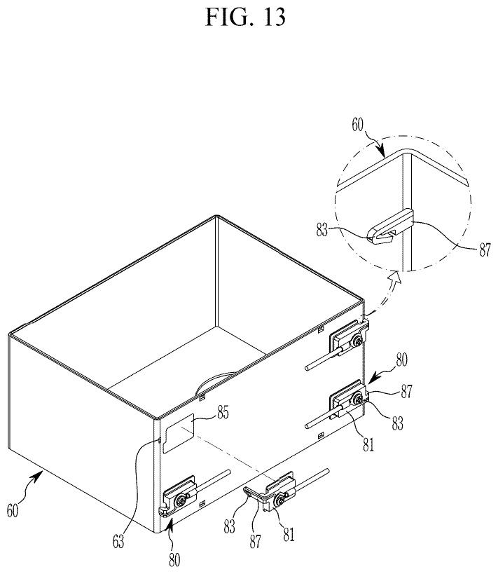

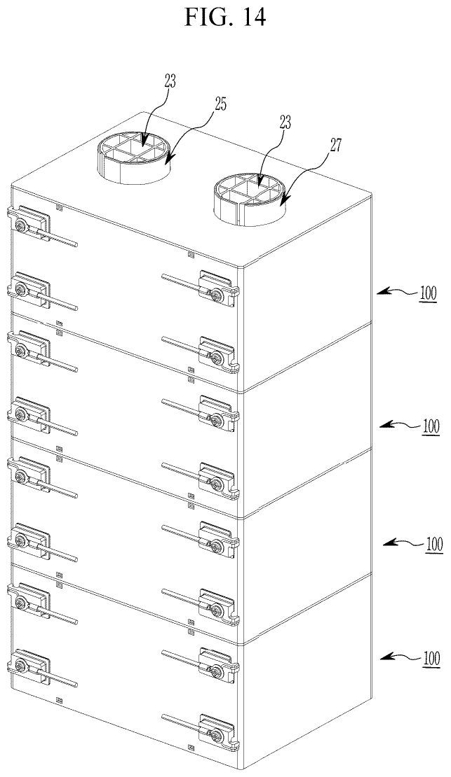

FIG. 13 shows a sensing block unit applied to a battery cell assembly according to an embodiment.

Referring to FIG. 13, each of the plurality of sensing block units 80 according to an embodiment includes a block body 81 and a connector 83.

The block body 81 is coupled to an outer surface of the cell housing 60. The block body 81 may be adhered to the outer surface of the cell housing 60 through a double-sided adhesive tape 85.

In addition, the connector 83 is coupled to a hook protrusion 87 extending from the block body 81 toward an interior of the cell housing 60. The connector 83 is electrically connected to the at least one first electrode terminal 21 (refer to FIGS. 1-3) and at least one second electrode terminal 41 (refer to FIGS. 1-3).

The hook protrusion 87 and the connector 83 may penetrate an engagement hole 63 formed on the cell housing 60 and be coupled to the interior of the cell housing 60.

Furthermore, the hook protrusion 87 and the connector 83 may be hook-coupled to the first hook groove 33 and the second hook groove 38 of the first terminal plate 20 as shown in FIGS. 7-9, and to the third hook groove 53 and the fourth hook groove 58 of the second terminal plate 40 as shown in FIGS. 10-12.

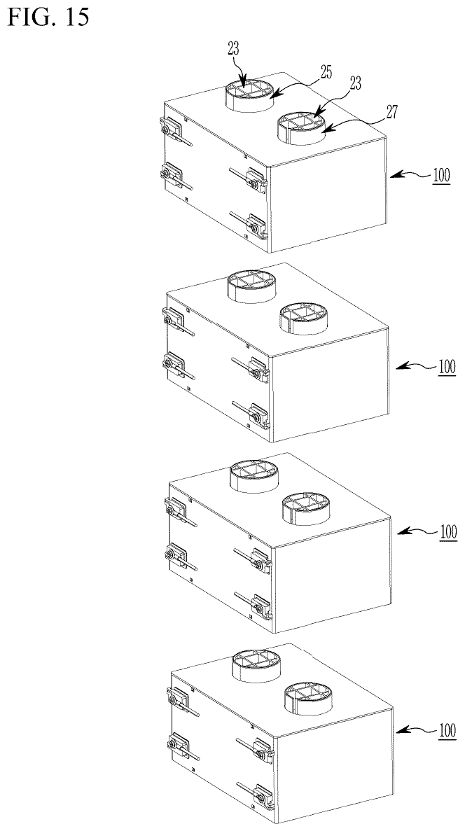

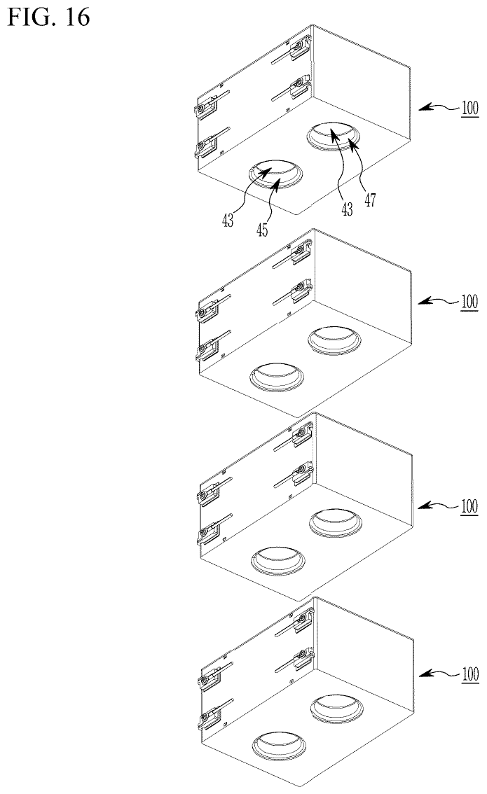

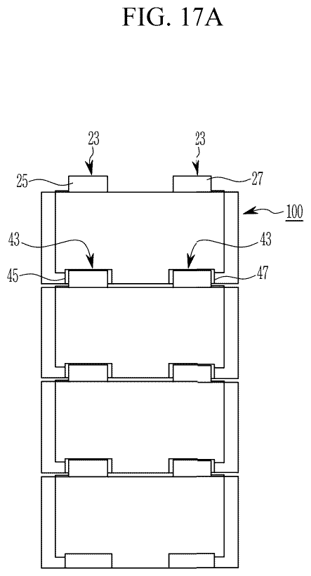

Hereinafter, the assembly or manufacturing operation of the battery cell assembly 100 according to an embodiment configured as described above is described in detail with reference to FIGS. 1-17A.

FIG. 14-17A show an operation of assembling a battery cell assembly according to an embodiment.

As shown in FIGS. 1-13, in order manufacture the battery cell assembly 100 according to an embodiment, the folding cell 10 is first provided in which the solid-state unit cell 1 in the sheet form is folded in the S-shape.

The first terminal plate 20 is disposed on a first side (e.g., upper portion) with reference to the folding direction of the folding cell 10.

The first terminal plate 20 is electrically connected to the positive electrode lead 15 and the negative electrode lead 17 of the folding cell 10 through the first positive electrode terminal 25 and the first negative terminal 27. The first positive electrode terminal 25 and the first negative terminal 27 are respectively coupled to the pair of protrusion portions 23 formed on the first terminal plate 20.

In addition, the second terminal plate 40 is disposed on a second side (e.g., lower portion) with reference to the folding direction of the folding cell 10.

The second terminal plate 40 is electrically connected to the positive electrode lead 15 and the negative electrode lead 17 of the folding cell 10 through the second positive electrode terminal 45 and the second negative terminal 47. The second positive electrode terminal 45 and the second negative terminal 47 are respectively coupled to the pair of recess portions 43 formed on the second terminal plate 40.

The folding cell 10, the first terminal plate 20, and the second terminal plate 40 that are connected to each other are placed and accommodated in the interior of the cell housing 60. In addition, the housing cover 70 is positioned to cover the cell housing 60.

The pair of recess portions 43 connected to the pair of first penetration holes 61 formed in the cell housing 60. In addition, the pair of protrusion portions 23 are inserted into the pair of second penetration holes 71 formed in the housing cover 70.

Furthermore, the plurality of sensing block units 80 is coupled to the cell housing 60. Each connector 83 of the plurality of sensing block units 80 is electrically connected to the first positive electrode terminal 25, the first negative terminal 27, the second positive electrode terminal 45, and the second negative terminal 47.

In the interior of the cell housing 60, each of the connector 83 is hook-coupled, through the hook protrusion 87, to the first hook groove 33 and the second hook groove 38 of the first terminal plate 20 and to the third hook groove 53 and the fourth hook groove 58 of the second ten final plate 40.

When the first terminal plate 20 and the second terminal plate 40 are accommodated in the interior of the cell housing 60, the connector 83 may be hook-coupled to the first hook groove 33, the second hook groove 38, the third hook groove 53, and the fourth hook groove 58 through the hook protrusion 87.

As shown in FIGS. 14-16, the battery cell assembly 100 according to an embodiment may be configured in a prismatic type and provided in a plural quantity, i.e., a plurality of the battery cell assemblies 100 may be stacked and connected to one another.

The plurality of battery cell assemblies 100 according to an embodiment may be assembled by connecting one battery cell assembly 100 with another neighboring battery cell assembly 100 in the form of bricks through the pairs of protrusion portions 23 and the corresponding pairs of recess portions 43 (refer to FIGS. 14-17A).

In other words, the plurality of battery cell assemblies 100 according to an embodiment may be assembled as a cell array of a required quantity as the pair of protrusion portions 23 formed in one battery cell assembly 100 are fitted with the pair of recess portions 43 formed in another the battery cell assembly 100.

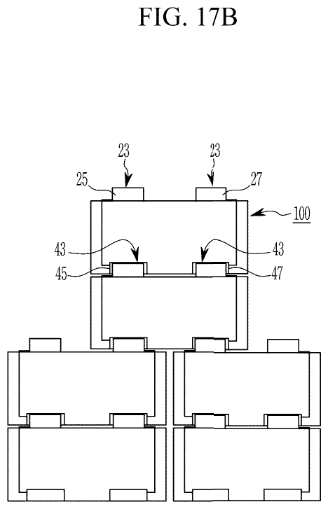

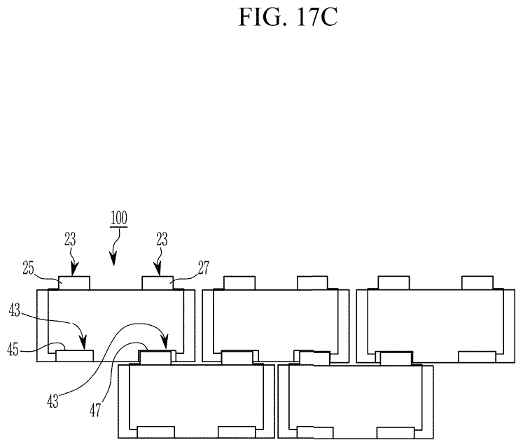

As shown in FIG. 17A, the plurality of battery cell assemblies 100 according to an embodiment may be electrically interconnected (e.g., connection in parallel) through the first positive electrode terminal 25, the first negative terminal 27, the second positive electrode terminal 45, and the second negative terminal 47 coupled to the pair of protrusion portions 23 and the pair of recess portions 43.

Furthermore, as shown in FIGS. 17B and 170, the plurality of battery cell assemblies 100 according to other embodiments may be interconnected in various other brick assembly methods or arrangements (e.g., bi-directional cell connection method) to form a cell array connected in series/in parallel.

Such a cell array may be mounted in an interior of a pack housing (not shown) and the pack housing may be mounted in a lower portion of the vehicle body.

The battery cell assembly 100 according to an embodiment as described above is applied with the folding cell 10 in which the solid-state unit cell 1 in the sheet form is folded in the S-shape.

Therefore, according to the battery cell assembly 100 according to an embodiment, voltage capacity of the solid-state unit cell 1 may be increased and volumetric efficiency of the battery cell in a limited space may be maximized.

In addition, according to the battery cell assembly 100 according to an embodiment, an electrical connection between cells may be enabled by a brick assembly method instead of engagement or welding and a sensing block unit 80 may be electrically connected to the folding cell 10 in a hook-coupling method.

Accordingly, for the battery cell assembly 100 according to an embodiment, the number of parts and assembly processes required for assembling the battery assembly may be reduced.

Furthermore, due to the characteristics of the solid-state unit cell 1, the battery cell assembly 100 according to an embodiment may provide the features of no cooling and no pressurization and may be assembled to the pack tray in the cell-to-pack (CTP) structure. Accordingly, components for cooling the battery cell and components for pressurizing the battery cell may be removed from the battery assembly.

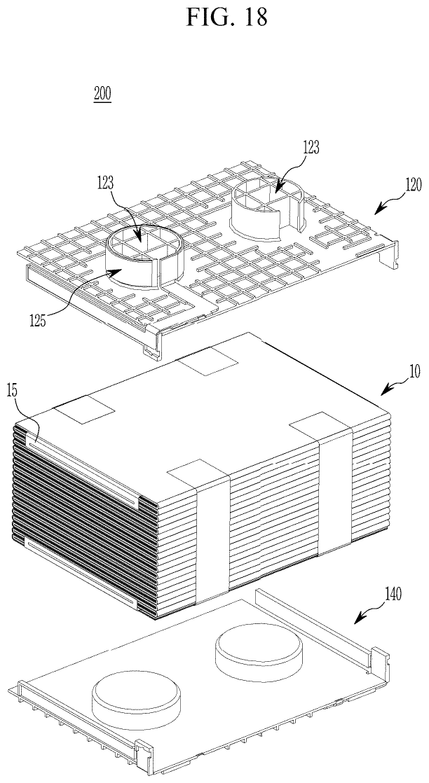

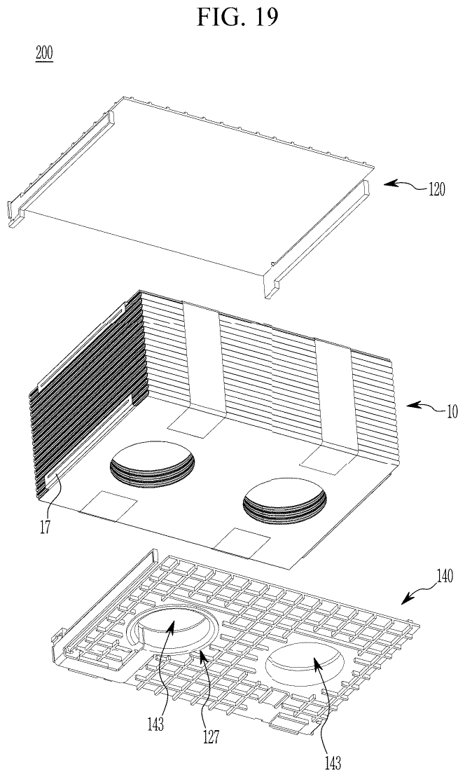

FIGS. 18-20 show views of a battery cell assembly according to another embodiment. In the drawings, the same reference numerals are assigned to the same elements as those of the previous embodiment.

Referring to FIGS. 18-20, a battery cell assembly 200 according to another embodiment may include a first terminal plate 120 in which a first positive electrode terminal 125 is coupled to only one of a pair of protrusion portions 123.

The first positive electrode terminal 125 may be electrically connected to the positive electrode lead 15 of the folding cell 10 as in the above embodiment.

In addition, the battery cell assembly 200 may include a second terminal plate 140 in which a first negative terminal 127 is coupled to only one of a pair of recess portions 143.

The first negative terminal 127 may be electrically connected to the negative electrode lead 17 of the folding cell 10 as in the above embodiment.

The battery cell assembly 200 configured as described above may again be provided in a plural quantity.

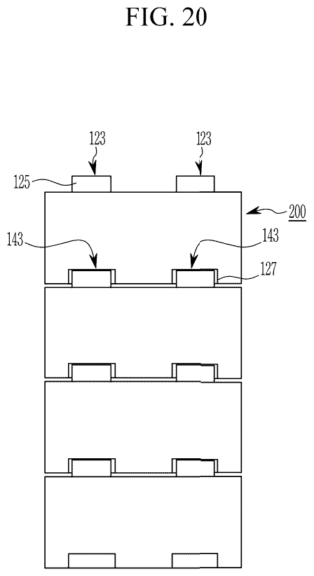

Therefore, as shown in FIG. 20, a plurality of battery cell assemblies 200 may be assembled by connecting a battery cell assembly 200 with another neighboring battery cell assembly 200, and so on, in the form of bricks through the pairs of protrusion portions 123 and the corresponding pairs of recess portions 143.

The plurality of battery cell assemblies 200 may be electrically interconnected (e.g., unidirectionally connected in series) through the first positive electrode terminal 125 and the first negative terminal 127.

The remaining configuration, operation, and effect of the battery cell assembly 200 is the same as the above embodiment and is not described here again.

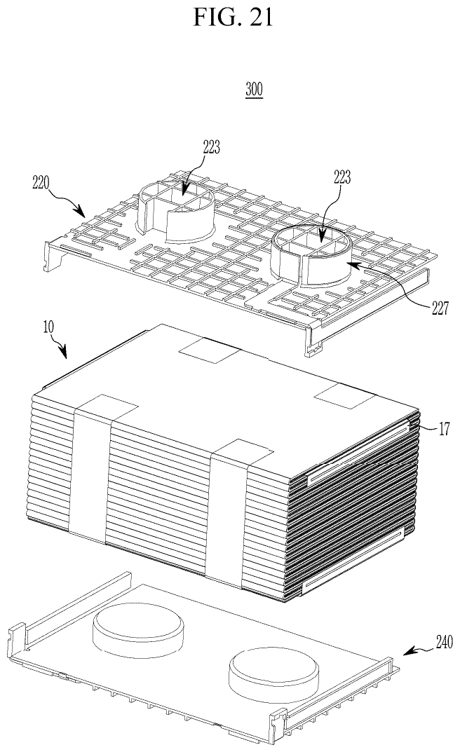

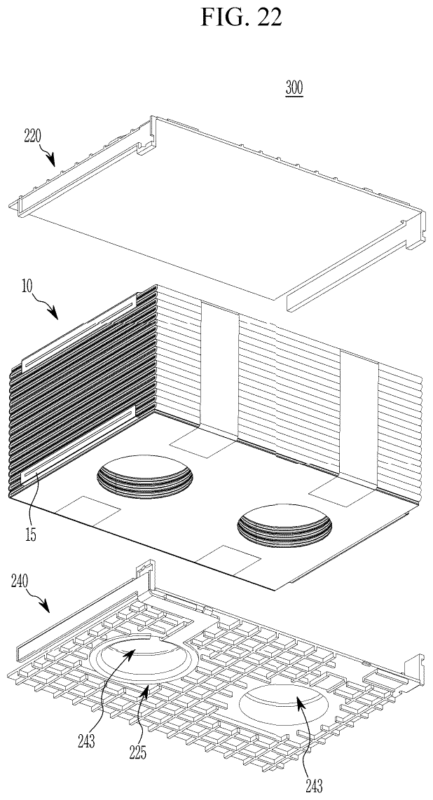

FIGS. 21-23 show views of a battery cell assembly according to another embodiment. In the drawings, the same reference numerals are assigned to the same elements as those of the previous embodiments.

Referring to FIGS. 2123, a battery cell assembly 300 according to still another embodiment may include a first terminal plate 220 in which a first negative terminal 227 is coupled to only one of a pair of protrusion portions 223.

The first negative terminal 227 may be electrically connected to the negative electrode lead 17 of the folding cell 10 as in the above embodiment.

In addition, the battery cell assembly 300 may include a second terminal plate 240 in which a first positive electrode terminal 225 is coupled to only one of a pair of recess portions 243.

The first positive electrode terminal 225 may be electrically connected to the positive electrode lead 15 of the folding cell 10 as in the above embodiment.

The battery cell assembly 300 according to still another embodiment configured as described above may again be provided in a plural quantity.

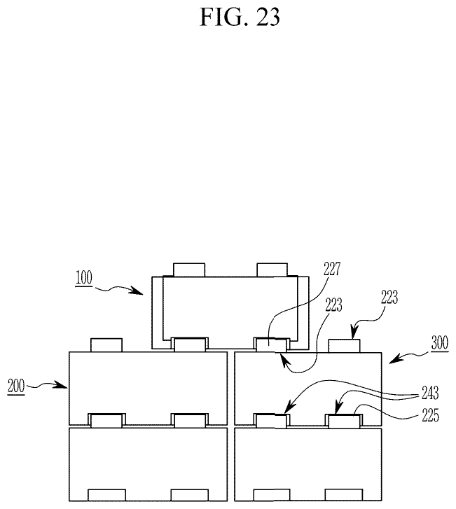

Therefore, as shown in FIG. 23, a plurality of battery cell assemblies 300 may be assembled by connecting a battery cell assembly 300 with another neighboring battery cell assembly 300, and so one, in the form of bricks through the pairs of protrusion portions 223 and the corresponding pairs of recess portions 243.

Furthermore, the plurality of battery cell assemblies 300 may be assembled, in the form of bricks, with at least one battery cell assembly 100 and 200 according to the above embodiments.

The plurality of battery cell assemblies 300 and the at least one battery cell assembly 100 and 200 according to the above embodiments may be electrically connected (e.g., connected in series/in parallel) between cells in various brick assembly methods (e.g., bi-directional and unidirectional cell connection method).

The plurality of battery cell assemblies 100, 200, and 300 described above may be electrically connected (e.g., connected in series/in parallel) between cells in various brick assembly methods (e.g., bi-directional and unidirectional cell connection methods).

The remaining configuration, operation, and effect of the battery cell assembly 300 is the same as the above-described embodiment and is not described here again.

While the technical concepts of this disclosure have been described in connection with what are presently considered to be practical embodiments, it is to be understood that the disclosure is not limited to the disclosed embodiments. On the contrary, it is intended to cover various modifications and equivalent arrangements included within the spirit and scope of the appended claims.

<Description of symbols>

| | |
|---|---|
| 1: solid-state unit cell | 2: negative electrode current |
| | collector |
| 3: lithium metal layer | 4: solid electrolyte membrane |
| 5: positive electrode active material | |
| 6: positive electrode current collector | |
| 7: punched hole | 8: folding section |
| 10: folding cell | 11: folding layer |
| 13: fixing tape | 15: positive electrode lead |
| 17: negative electrode lead | 19: coupling hole |
| 20, 120, 220: first terminal plate | |
| 21: first electrode terminal | |
| 23, 123, 223: protrusion portion | |
| 25, 125, 225: first positive electrode | |
| terminal | |
| 26: first terminal portion | 27, 127, 227: first negative |
| | terminal |
| 29: first sensing busbar | 31: first rib |
| 33: first hook groove | 35: second terminal portion |
| 36: second rib | 37: second sensing busbar |
| 38: second hook groove | 40, 140, 240: second terminal |
| | plate |
| 41: second electrode terminal | |
| 43, 143, 243: recess portion | |
| 45: second positive electrode terminal | |
| 46: third terminal portion | |
| 47: second negative terminal | |
| 49: third sensing busbar | |
| 51: third rib | 53: third hook groove |
| 55: fourth terminal portion | 56: fourth rib |
| 57: fourth sensing busbar | 58: fourth hook groove |
| 59: cell coupling protrusion | 60: cell housing |
| 61: first penetration hole | 63: engagement hole |
| 70: housing cover | 71: second penetration hole |
| 80: sensing block unit | 81: block body |
| 83: connector | 85: double-sided adhesive |
| | tape |
| 87: hook protrusion | |
| 100, 200, 300: battery cell | |
| assembly | |

What is claimed is:

1. A battery cell assembly, comprising:
a folding cell in which a solid-state unit cell in a sheet form is folded in a zigzag form;
a first terminal plate disposed on a first side with reference to a folding direction of the folding cell, electrically connected to the folding cell through at least one first electrode terminal, and formed with at least one protrusion portion configured to support the at least one first electrode terminal; and
a second terminal plate disposed on a second side with reference to the folding direction of the folding cell, electrically connected to the folding cell through at least one second electrode terminal, and formed with at least one recess portion configured to support the at least one second electrode terminal.

2. The battery cell assembly of claim 1, further comprising:
a cell housing including a first penetration hole connected to the at least one recess portion, the cell housing configured to accommodate the folding cell, the first terminal plate, and the second terminal plate that are connected to each other; and
a housing cover including a second penetration hole into which the at least one protrusion portion is inserted, the housing cover coupled to the cell housing.

3. The battery cell assembly of claim 1, wherein:
the battery cell assembly is configured in a prismatic type; and
the battery cell assembly is assembled with a neighboring battery cell assembly in the form of bricks through the at least one protrusion portion of the battery cell assembly and at least one recess portion of the neighboring battery cell assembly.

4. The battery cell assembly of claim 1, wherein the folding cell further comprises a fixing tape adhered along the folding direction to a plurality of folding layers folded in as S-shape.

5. The battery cell assembly of claim 1, wherein:
the second terminal plate comprises a cell coupling protrusion formed with the at least one recess portion; and
the folding cell is formed with a coupling hole coupled to the cell coupling protrusion.

6. The battery cell assembly of claim 1, wherein the at least one first electrode terminal and the at least one second electrode terminal comprise:
a terminal portion in a ring shape; and
a sensing busbar extending from the terminal portion and electrically connected to at least one among a positive electrode lead and a negative electrode lead provided in the folding cell.

7. The battery cell assembly of claim 6, wherein the first terminal plate and the second terminal plate are formed of an insulation material and comprise a rib configured to support the sensing bulbar.

8. The battery cell assembly of claim 1, wherein the at least one protrusion portion is provided in as a pair of protrusion portions, and wherein the at least one first electrode terminal comprises:
a first positive electrode terminal coupled to a first protrusion portion of the pair of protrusion portions and is electrically connected to a positive electrode lead provided in the folding cell; and
a first negative terminal coupled to a second protrusion portion of the pair of protrusion portions and is electrically connected to a negative electrode lead provided in the folding cell.

9. The battery cell assembly of claim 8, wherein the at least one recess portion is provided as a pair of recess portions, and wherein the at least one second electrode terminal comprises:
a second positive electrode terminal coupled to a first recess portion of the pair of recess portions and is electrically connected to the positive electrode lead provided in the folding cell; and
a second negative terminal coupled to a second recess portion of the pair of recess portions and is electrically connected to the negative electrode lead provided in the folding cell.

10. The battery ell assembly of claim 2, further comprising a plurality of sensing block units coupled to the cell housing, and electrically connected to the at least one first electrode terminal and the at least one second electrode terminal.

11. The battery cell assembly of claim 10, wherein the plurality of sensing block units comprises:
a block body coupled to the cell housing; and
a connector coupled to a hook protrusion extending from the block body toward an interior of the cell housing and electrically connected to the at least one first electrode terminal and the at least one second electrode terminal.

12. The battery cell assembly of claim 11, wherein the block body is adhered to an outer surface of the cell housing through a double-sided adhesive tape.

13. The battery cell assembly of claim 11, wherein a hook groove coupled to the hook protrusion and the connector is formed in the first terminal plate and the second terminal plate.

14. The battery assembly of claim 1, wherein:
the protrusion portion is provided as a pair of protrusion portions; and
the at least one first electrode terminal comprises a first positive electrode terminal coupled to a first protrusion portion of the pair of protrusion portions and is electrically connected to a positive electrode lead provided in the folding cell.

15. The battery cell assembly of claim 14, wherein:
the recess portion is provided as a pair of recess portions; and
the at least one second electrode terminal comprises a first negative terminal coupled to a first recess portion of the pair of recess portions and is electrically connected to a negative electrode lead provided in the folding cell.

16. The battery cell assembly of claim 1, wherein:
the protrusion portion is provided as a pair of protrusion portions; and
the at least one first electrode terminal comprises a first negative terminal coupled to a first protrusion portion of the pair of protrusion portions and is electrically connected to a negative electrode lead provided in the folding cell.

17. The battery cell assembly of claim 16, wherein:
the recess portion is provided as a pair of recess portions; and
the at least one second electrode terminal comprises a first positive electrode terminal coupled to a first recess portion of the pair of recess portions and is electrically connected to a positive electrode lead provided in the folding cell.
